(19) United States
(12) Patent Application Publication
(10) Pub. No.: US 2018/0358158 A1
(43) Pub. Date: Dec. 13, 2018

(54) SOLENOID AND METHOD FOR FORMING A SOLENOID

(71) Applicant: BorgWarner Inc., Auburn Hills, MI (US)

(72) Inventor: Christopher E. Blair, Fenton, MI (US)

(21) Appl. No.: 16/000,943

(22) Filed: Jun. 6, 2018

Related U.S. Application Data
(60) Provisional application No. 62/516,222, filed on Jun. 7, 2017.

(51) Int. Cl. H01F 7/127; H01F 41/04; H01F 7/16

(52) U.S. Cl. CPC H01F 7/127; B21F 3/00; H01F 7/1607; H01F 41/04

(57) ABSTRACT

A solenoid includes a tubular core formed of a magnetically susceptible material, an annular electromagnetic coil disposed about the tubular core, and an armature assembly received in the tubular core and movable relative to the tubular core along a longitudinal axis of the tubular core. The armature assembly includes an armature and a polymer material. The armature is formed of a magnetically susceptible material and has an armature surface that is disposed about the axis of the tubular core. The polymer material is fixedly coupled to the armature and is uniformly disposed over the armature surface. A method for forming a solenoid is also provided.

### CROSS-REFERENCE TO RELATED APPLICATIONS

This application claims the benefit of U.S. Patent Application No. 62/516,222 filed on Jun. 7, 2017, the disclosure of which is herein incorporated by reference in its entirety.

### INTRODUCTION

The present invention generally relates to a solenoid and a method for forming a solenoid.

### BACKGROUND

One conventional configuration of a solenoid employs a tubular core, an electromagnetic coil disposed about the core, and an armature that is slidably received in the core. The armature can be moved relative to the core by energizing the electromagnetic coil. Various materials have been employed to reduce friction between the armature and the inside surface of the tubular core, such as nickel plating, direct polymer deposition and the insertion of a loose sheet of polymer film between the core and the armature. Each of these methods introduces unique manufacturing difficulties, including costly electroplating, redundant grinding processes and error proofing of the assembly process. Accordingly, there remains a need in the art for an improved solenoid and a method for its formation.

### SUMMARY

This section provides a general summary of some aspects of the present disclosure and is not a comprehensive listing or detailing of either the full scope of the disclosure or all of the features described therein.

In one form, the present teachings provide a solenoid that includes a tubular core formed of a magnetically susceptible material, an annular electromagnetic coil disposed about the tubular core, and an armature assembly received in the tubular core and movable relative to the tubular core along a longitudinal axis of the tubular core. The armature assembly includes an armature and a polymer material. The armature is formed of a magnetically susceptible material and has an armature surface that is disposed about the axis of the tubular core. The polymer material is fixedly coupled to the armature and is uniformly disposed over the armature surface.

In another form, the present teachings provide a method for forming a solenoid. The method includes: providing an armature having a longitudinal axis, the armature having an armature surface that is disposed about the longitudinal axis; inserting the armature into a polymer tube; forming an armature assembly by shrinking the polymer tube onto the armature surface to fixedly couple the polymer tube to the armature; providing a solenoid body having a core and a coil, the core having a tubular core portion, the coil being disposed about the tubular core portion; and inserting the armature assembly into the core.

Further areas of applicability will become apparent from the description provided herein. It should be understood that the description and specific examples in this summary are intended for purposes of illustration only and are not intended to limit the scope of the present disclosure, its application and/or uses in any way.

### BRIEF DESCRIPTION OF THE DRAWINGS

The drawings described herein are for illustrative purposes only and are not intended to limit the scope of the present disclosure in any way. The drawings are illustrative of selected teachings of the present disclosure and do not illustrate all possible implementations. Similar or identical elements are given consistent identifying numerals throughout the various figures.

FIG. 1 is a longitudinal section view of an exemplary solenoid constructed in accordance with the teachings of the present disclosure; and

FIG. 2 is an exploded perspective view of a portion of the solenoid of FIG. 1, illustrating the configuration of an armature assembly in more detail.

Corresponding reference numerals indicate corresponding parts throughout the several views of the drawings.

### DETAILED DESCRIPTION OF THE VARIOUS EMBODIMENTS

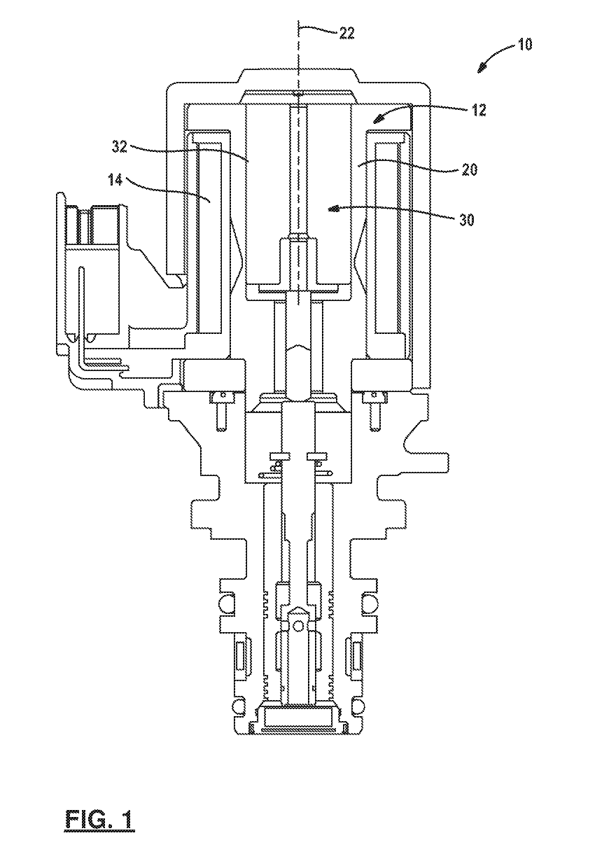

With reference to FIG. 1, an exemplary solenoid constructed in accordance with the teachings of the present disclosure is generally indicated by reference numeral 10. The solenoid 10 can include a core 12, an electromagnetic coil 14 and an armature assembly 16. The core 12 can include a tubular core portion 20 that can have a longitudinal axis 22. The tubular core portion 20 can be formed of a magnetically susceptible material, such as steel. The electromagnetic coil 14 can be formed in a conventional manner of a plurality of turns of a conductive wire and can be disposed about the tubular core portion 20.

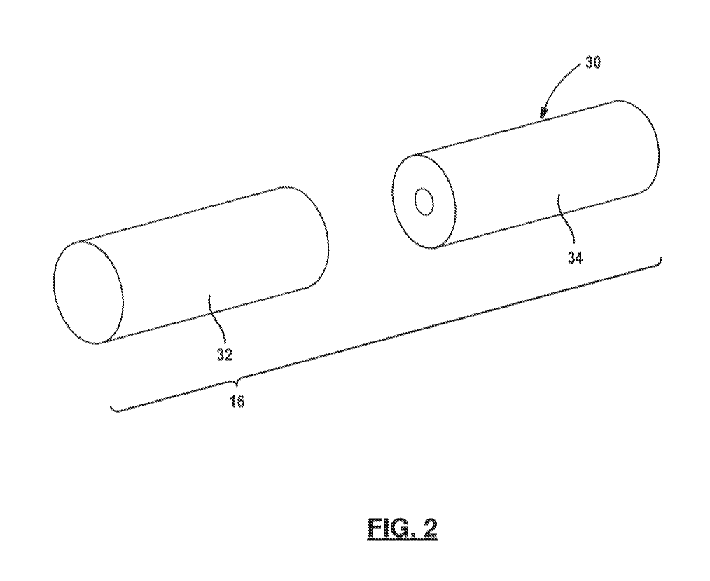

The armature assembly 16 can be slidably received in the tubular core portion 20 for movement along the axis 22. With additional reference to FIG. 2, the armature assembly 16 can include an armature 30 and a polymer tube 32. The armature 30 can be formed of a magnetically susceptible material, such as steel, and can define an armature surface 34 that can extend about the axis 22. The polymer tube 32, which can be formed of a material that is not magnetically susceptible, can be disposed uniformly over the armature surface 34. The material of which polymer tube 32 is formed can be selected to provide one or more desired characteristics, such as a coefficient of static or dynamic friction that is relatively lower than the coefficient of static or dynamic friction of the armature surface 34, which can be ground and could possibly be polished. Examples of suitable polymers that can be employed for the material that forms the polymer tube 32 include fluropolymers, such as fluorinated ethylene propylene (FEP), perfluoroalkoxy alkane (PFA), and polytetrafluoroethylene (PTFE).

One method for forming the solenoid 10 includes providing a polymer material in the form of a tube (i.e., the polymer tube 32) having an inside diameter that is larger than the outside diameter of the armature 30, inserting the armature 30 into the polymer tube 32, and shrinking the polymer tube 32 onto the armature surface 34 to fixedly couple the polymer material that forms the polymer tube 32 to the armature 30. In this regard, the armature 30 is inserted into the polymer tube 32 and at least one of the polymer tube 32 and the armature 30 is heated to cause the polymer tube 32 to shrink and fixedly engage to the armature surface 34. Various means can be employed to heat the polymer tube 32 and/or the armature 30, including ovens (e.g., conventional ovens, convection ovens, infrared ovens, and combinations thereof) and/or an induction heater. Preferably, the polymer tube 32 is sized and the polymer material from which the polymer tube 32 is formed is selected so that the polymer material is uniformly distributed over the armature 30 (i.e., the polymer material has a consistent thickness that does not exceed a desired maximum thickness) and the outside diameter of the armature assembly 16 is sized within predetermined tolerance. If desired, an outside surface of the polymer tube 32 can be machined in an appropriate process, such as centerless grinding, after the polymer tube 32 has been fixedly coupled to the armature surface 34.

It will be appreciated that the above description is merely exemplary in nature and is not intended to limit the present disclosure, its application or uses. While specific examples have been described in the specification and illustrated in the drawings, it will be understood by those of ordinary skill in the art that various changes may be made and equivalents may be substituted for elements thereof without departing from the scope of the present disclosure as defined in the claims. Furthermore, the mixing and matching of features, elements and/or functions between various examples is expressly contemplated herein, even if not specifically shown or described, so that one of ordinary skill in the art would appreciate from this disclosure that features, elements and/or functions of one example may be incorporated into another example as appropriate, unless described otherwise, above. Moreover, many modifications may be made to adapt a particular situation or material to the teachings of the present disclosure without departing from the essential scope thereof. Therefore, it is intended that the present disclosure not be limited to the particular examples illustrated by the drawings and described in the specification as the best mode presently contemplated for carrying out the teachings of the present disclosure, but that the scope of the present disclosure will include any embodiments falling within the foregoing description and the appended claims.

What is claimed is:

1. A solenoid comprising:
a tubular core formed of a magnetically susceptible material, the tubular core defining a core axis;
an annular electromagnetic coil disposed about the tubular core; and
an armature assembly received in the tubular core and movable relative to the tubular core along the core axis, the armature assembly comprising an armature and a polymer material, the armature being formed of a magnetically susceptible material and having an armature surface that is disposed about the core axis, the polymer material being fixedly coupled to the armature and uniformly disposed over the armature surface.

2. The solenoid of claim 1, wherein the polymer material is formed of a fluropolymer.

3. The solenoid of claim 2, wherein the fluoropolymer is fluorinated ethylene propylene (FEP), perfluoroalkoxy alkane (PFA), or polytetrafluoroethylene (PTFE).

4. A method for fabricating a solenoid, the method comprising:
providing an armature having a longitudinal axis, the armature having an armature surface that is disposed about the longitudinal axis;
inserting the armature into a polymer tube;
forming an armature assembly by shrinking the polymer tube onto the armature surface to fixedly couple the polymer tube to the armature;
providing a solenoid body having a core and a coil, the core having a tubular core portion, the coil being disposed about the tubular core portion; and
inserting the armature assembly into the core.

5. The method of claim 4, wherein forming the armature assembly includes heating at least one of the armature and the polymer tube.

6. The method of claim 5, wherein heating at least one of the armature and the polymer tube comprises induction heating the armature.

7. The method of claim 4, wherein an outer surface of the polymer tube is machined in a machining operation after the polymer tube is shrunk onto the armature surface and prior to inserting the armature assembly into the core.

8. The method of claim 7, wherein the machining operation comprises centerless grinding.
